(19) United States
(12) Patent Application Publication
(10) Pub. No.: US 2023/0064339 A1
(43) Pub. Date: Mar. 2, 2023

(54) Neonatal Feeding Syringe with an Internal Mixing Disc

(71) Applicants: Anant Mathur, Cupertino, CA (US); Ish Gulati, Cupertino, CA (US)

(72) Inventors: Anant Mathur, Cupertino, CA (US); Ish Gulati, Cupertino, CA (US)

(21) Appl. No.: 17/892,859

(22) Filed: Aug. 22, 2022

Related U.S. Application Data
(60) Provisional application No. 63/238,953, filed on Aug. 31, 2021.

(51) Int. Cl. A61J 7/00

(52) U.S. Cl. CPC A61J 7/0053

(57) ABSTRACT

Embodiments of the present invention comprise an enteral syringe that, in a horizontal orientation, delivers more consistent nutrition throughout the feeding cycle by using a mixing disc that creates a path for milk from fat accumulating on top of the syringe's barrel to flow to the syringe's outlet, whereupon it is mixed into an emulsion. The distal face of the syringe's piston can be coated with, or made out of, a lipophobic material, which prevents fat accumulation, especially towards the end of the feeding cycle.

### CROSS-REFERENCE TO RELATED APPLICATIONS

This application claims the benefit of U.S. Provisional application Ser. No. 63/238,953 filed Aug. 31, 2021, which is incorporated herein by reference in its entirety.

### TECHNICAL FIELD

Embodiments of the invention relate to a syringe-type of feeding device used for feeding recently born preterm infants (“neonates”).

### BACKGROUND

A significant portion (˜11%) of all infant deliveries in the US are preterm (born within 24-36 weeks of gestation, versus full term at 40 weeks). After birth, neonates are typically cared for in Neonatal ICU's (NICUs) until they are sufficiently developed to go home, a period that can last several weeks. In NICUs, mother's milk is the best (and often exclusive) nutrition source for neonates. Over 50% of the nutritional value of mother's milk comes from the 10% content (by volume) that is fat and triglyceride content, so it is very important for the precious fat content to be fully delivered to the neonate. Unlike typical store-bought milk consumed by adults, mother's milk and colostrum is not homogenized, as a result during a typical feed cycle the milkfat often separates out and adheres to the wall of syringe and the tubings leading to fat loss in the neonate's diet.

A typical setup for neonate feeding is milk loaded in an enteral syringe mounted horizontally in a mechanical infusion pump. The duration of feed can be long (60 min or more), during which time fat globules initially dispersed in the milk can agglomerate and (due to lower relative density) separate out to the top as a layer of fat. As a result the fat is not consistently infused into the feeding tube, which results in non-uniform quality of milk delivered to the infant through the feed cycle; a well-recognized problem in neonatal care.

Against this background, the present invention was developed.

### SUMMARY OF THE INVENTION

Embodiments of the present invention comprise an enteral syringe that, in a horizontal orientation, delivers more consistent nutrition throughout the feeding cycle by using a mixing disc that creates a path for milk from fat accumulating on top of the syringe's barrel to flow to the syringe's outlet, whereupon it is mixed into an emulsion. The distal face of the syringe's piston can be coated with, or made out of, a lipophobic material, which prevents fat accumulation, especially towards the end of the feeding cycle.

The neonatal feeding syringe can comprise:

a syringe comprising a tubular barrel defining an internal lumen, an open proximal end, and a distal end of the barrel comprising a nozzle in fluid communication with the lumen;

a plunger movably mounted within the lumen of the barrel, having a piston surface disposed on a distal end of the plunger, wherein the piston surface fluidically seals the lumen of the syringe barrel such that fluid is prevented from exiting an open proximal end of the barrel; and

a perforated mixing disc disposed within the lumen of the barrel, distal from the piston surface and proximal to the nozzle; the mixing disc comprising a proximally-facing face with a plurality of entry ports and a distally-facing face provided with a single, common exit port, wherein each entry port is individually connected to the common exit port by a channel that passes through the disc from the proximal face to the distal face of the mixing disc.

The mixing disc can be fixed within the barrel, or it can be free to move within the barrel. The piston's distal face can be coated with, or formed of, a lipophobic material. Alternatively, the mixing disc can be integrally formed with the syringe's barrel and is not removable. The entire inside surface of the barrel can be coated with a lipophobic material. The mixing disc can comprise a single exit port on the distal side of the disc; wherein the exit port has a larger diameter than the plurality of entry ports. The mixing disc can be adhesively attached to the distal end of the barrel, or friction-fit within the barrel. The mixing disc can comprise a rubber O-ring seal disposed around an outer circumference of the disc, which forms a seal against the lumen of the barrel. Finally, a mixing flow divertor can be supported within the barrel by a plurality of radially-oriented, integral, angled support vanes that impart a helical component of velocity of fluid flowing through channels defined by adjacent support vanes.

### BRIEF DESCRIPTION OF THE DRAWINGS

A more complete understanding of the embodiments, and the attendant advantages and features thereof, will be more readily understood by references to the following detailed description, when considered in conjunction with the accompanying drawings, wherein:

FIG. 1 shows a cross-section view of an exemplary feeding device with an internal mixing disc, according to the present invention.

FIG. 2 shows a proximal side view of an exemplary mixing disc, according to the present invention.

FIG. 3 shows a distal side view of an exemplary mixing disc, according to the present invention.

FIGS. 4A, 4B, and 4C show a proximal, cross-section, and distal view, respectively, of an exemplary mixing disc, according to the present invention.

FIGS. 5A, 5B, and 5C show a proximal, cross-section, and distal view, respectively, of an exemplary mixing disc, according to the present invention.

FIG. 6 shows a perspective view of an exemplary mixing disc, according to the present invention.

FIG. 7 shows a cross-section view of an exemplary mixing disc with an O-ring seal, according to the present invention.

FIG. 8 shows a cross-section view of an exemplary feeding device with an internal mixing disc, according to the present invention.

FIG. 9 shows a cross-section view of an exemplary feeding device with an integral mixing disc, according to the present invention.

FIG. 10 shows a cross-section view, SECTION A-A, of an exemplary barrel with an integral mixing body and a plurality of integral, straight support vanes, according to the present invention.

FIG. 11 shows a cross-section view, SECTION A-A, of an exemplary barrel with an integral mixing body and a plurality of integral, angled support vanes, according to the present invention.

### DETAILED DESCRIPTION OF THE INVENTION

The specific details of the single embodiment or variety of embodiments described herein are set forth in this application. Any specific details of the embodiments are used for demonstration purposes only, and no unnecessary limitation or inferences are to be understood therefrom.

Before describing in detail exemplary embodiments, it is noted that the embodiments reside primarily in combinations of components related to the system. Accordingly, the device components have been represented where appropriate by convention symbols in the drawings, showing only those specific details that are pertinent to understanding the embodiments of the present disclosure so as not to obscure the disclosure with details that will be readily apparent to those of ordinary skill in the art having the benefit of the description herein.

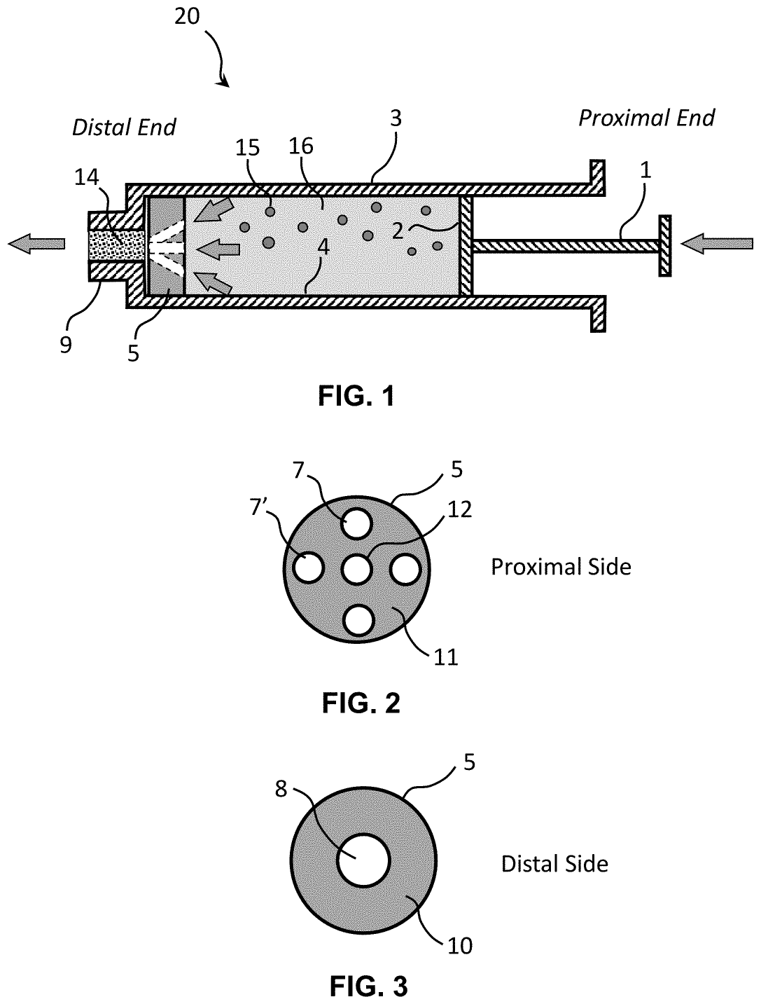

FIG. 1 shows a cross-section view of an exemplary device 20 with an internal mixing disc 5, according to the present invention. Device 20 includes a syringe comprising a tubular barrel 3 with an inner surface (lumen) 4, which is in fluid communication with an exit nozzle 9. A plunger 1 is movably mounted within the lumen 4 of the barrel 3. A proximal end of the plunger 1 is provided with an enlarged surface sized for a user's finger to push on. The distal end of the plunger 1 is provided with a piston surface 2. The piston surface 2 has a distally-facing surface 2D (which faces towards the nozzle 9 of barrel 3) and a proximally-facing surface 2P (which faces away from nozzle 9). According to one embodiment, the distally-facing surface 2D is either formed of, or is coated with, a lipophobic surface (e.g., Teflon™) to prevent fat accumulation thereon. Alternatively, the entire inside surface 4 of barrel 3 can be coated with a lipophobic material. The (shaded) interior volume of barrel 3 contains milk with fat globules 15, which may or may not be evenly suspended in a carrier liquid. Shaded exit region 14 disposed inside of nozzle 9 represents fully-mixed fluid containing fat globules 15 well-mixed with non-fat liquid 16 to form an emulsion.

Referring still to FIG. 1, the feeding device 20 further includes a perforated mixing disc 5 having a proximal face 10 (which faces away from nozzle 9) and a distal face 10 (which faces towards the nozzle 9 of barrel 3). A plurality of entry ports 7 is provided on the proximal face 9. Each of the plurality of entry ports 7 is fluidically coupled to a single exit port 8 that exits at the distal face 10. In a device having “X” number of entry ports 7, there are “X” number of lumens/channels 6 which fluidically couple the “X” number entry ports 7 to the single exit port 8. Just distal to the exit port 8, and inside of nozzle 9, is a mixing region 14 where fat and non-fat liquid completely mix together into a uniform dispersion of fluid/fat emulsion. Piston 1 can be driven by a motorized mechanism or pushed by hand.

FIG. 2 shows a proximal side view of an exemplary mixing disc 5, according to the present invention. Disc 5 comprises four thru-holes (entry ports) 7, 7′, etc. with a plurality of channels 6, 6′, etc. that are disposed at an angle to the disc's central axis. Channels 6, 6′, etc. fluidically connect the entry port 7, 7′, etc. to exit port 8, from proximal face 11 to distal face 10. Disc 5 further comprises a central hole 12 that is parallel to the disc's central axis, and which fluidically connects the proximal face 11 to the distal face 10.

FIG. 3 shows a distal side view of an exemplary mixing disc 5, according to the present invention. Disc 5 comprises a single exit hole (exit port) 8 on the distal side, which has a larger diameter than the diameter of thru-holes 7, 7′, etc.

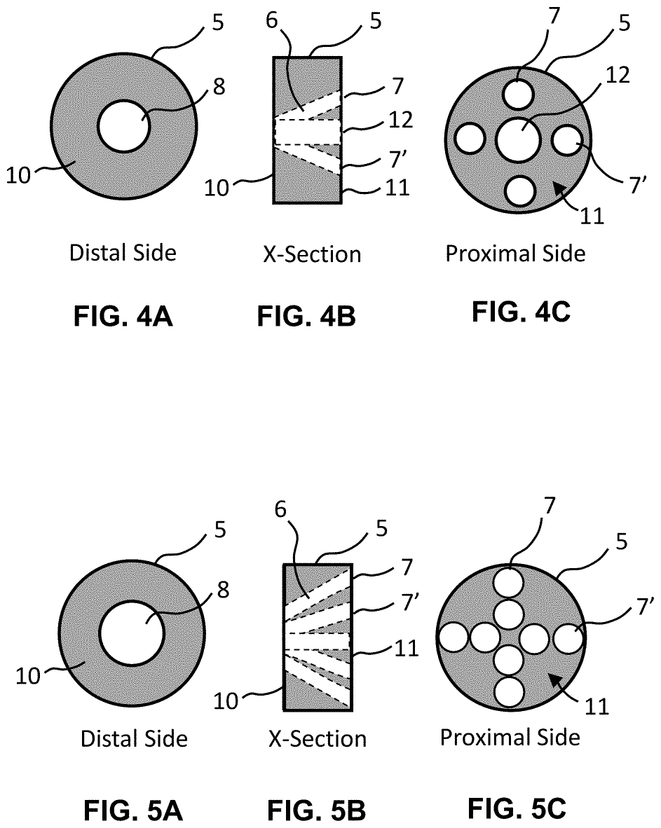

FIGS. 4A, 4B, 4C show a proximal, cross-section, and distal view, respectively, of an exemplary mixing disc 5, according to the present invention. Disc 5 comprises four holes (entry ports) 7, 7′, etc., with each port coupled to a thru-channel 6, 6′, etc. that is disposed at an angle to the disc's central axis, and that pass from the proximal face 11 to the distal face 10. Disc 5 further comprises a central hole 12 that is not angled and which can have a larger diameter than the thru-holes 7, 7′, etc.

FIGS. 5A, 5B, 5C show a proximal, cross-section, and distal view, respectively, of an exemplary mixing disc 5, according to the present invention. Disc 5 comprises eight holes (entry ports) 7, 7′, etc., with each port coupled to a thru-channel 6 that is disposed at an angle to the disc's central axis, and that pass from the proximal face 11 to the distal face 10. Eight entry port holes 7, 7′, etc are arranged in a square cross geometry without a central hole.

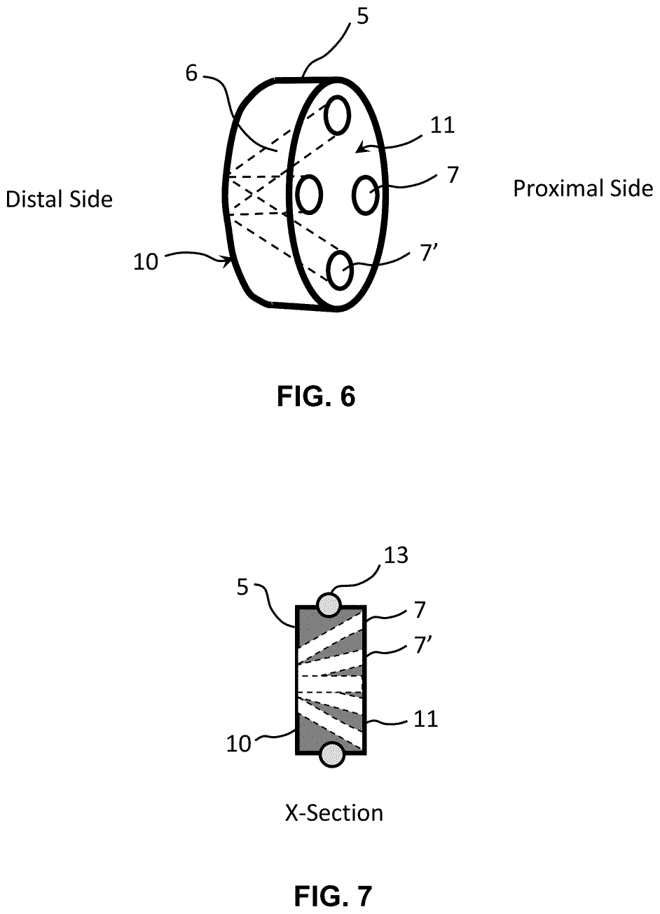

FIG. 6 shows a perspective view of an exemplary mixing disc 5, according to the present invention. Disc 5 comprises four holes (entry ports) 7, 7′, etc., with each port coupled to a thru-channel 6 that is disposed at an angle to the disc's central axis, and that pass from the proximal face 11 to the distal face 10.

FIG. 7 shows a cross-section view of an exemplary mixing disc 5 with an O-ring seal 13 disposed on a circumference of disc 5, according to the present invention.

According to one embodiment, the plurality of entry ports 7, 7′ are evenly spaced along a periphery of the proximal face 2P of disc 5.

According to another embodiment, the plurality of entry ports 7, 7′ are evenly spaced around the proximal face 2P of disc 5.

According to another embodiment, the plurality of entry ports 7, 7′ are evenly spaced along a periphery of the proximal face 2P of disc 5, and further includes a central entry port 12 fluidically connected to exit port 8.

According to another embodiment, mixing disc 5 is disposed within barrel 3 at a position that is distal to the piston surface 2 and proximal to the nozzle 9.

According to another embodiment, the mixing disc 5 is free-floating within barrel 3. A user moves the piston surface 2 distally by pushing on the proximal end of plunger 1. The piston surface 2 pushes the milk distally towards the mixing disc 5, which pushes disc 5 towards the distal end of barrel 3. Milk enters the plurality of entry port 7, 7′ and exits through the exit port 8. The milk is sufficiently mixed by the convergence of the plurality of channels 6 to a single exit port 8, in the region just outside distally to disc 5.

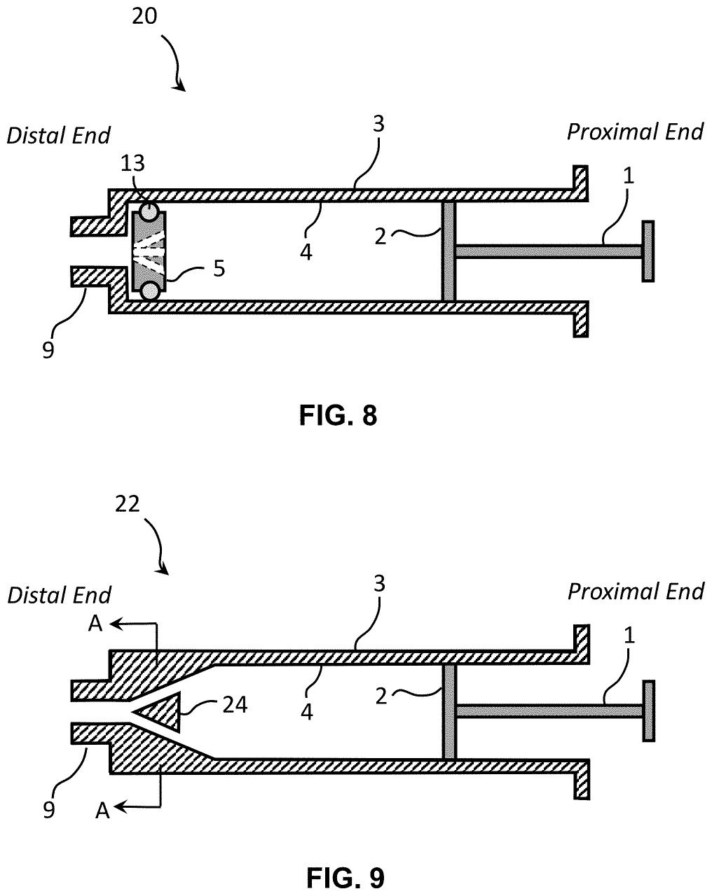

According to another embodiment, device 20 was previously described as two, separately manufactured components: i.e., mixing disc 5 that is assembled and inserted into a standard syringe barrel 3. Alternatively, the mixing disc 5 may be integrally formed (not shown) along with the syringe barrel 3. In this embodiment, barrel 3 can be integrally formed with the mixing disc 5 (e.g., by molding, over-molding, or 3-D printing), thereby simplifying the manufacturing process without altering the functionality of device 20. Alternatively, disc 5 may be adhesively attached to the distal end of barrel 3 (e.g., with cyanoacylrate “super-glue”). Alternatively, disc 5 may be friction-fit within the distal end of barrel 3. Alternatively, disc 5 can include a rubber O-ring seal 13 disposed around the outer circumference of disc 5, to form a better seal against the inner surface 4 of barrel 3. (See FIG. 8).

FIG. 9 shows a cross-section view of an exemplary device 22 with an integral flow divertor 24, according to the present invention. Device 22 includes a syringe barrel 3 comprising a tubular body with an inner surface (lumen) 4, which is in fluid communication with a nozzle 9. A plunger 1 is movably mounted within the lumen 4 of the barrel 3. A proximal end of the plunger 1 is provided with an enlarged surface sized for a user's finger. The distal end of the plunger 1 is provided with a piston surface 2. The piston surface 2 has a distally-facing surface 2D (which faces towards the nozzle 9 of barrel 3) and a proximally-facing surface 2P (which faces away from nozzle 9). According to one embodiment, the distally-facing surface 2D is either formed of, or is coated with, a lipophobic surface (e.g., Teflon™) to prevent fat accumulation thereon. Alternatively, the entire inside surface 4 of barrel 3 can be coated with a lipophobic material. Flow divertor 24 is held in place by a plurality of axially-oriented vanes (not shown) that are made integral with barrel 3 of device 22. In this embodiment, barrel 3 can be integrally formed with the flow divertor 24 (e.g., by casting, injection-molding, or 3-D printing), thereby simplifying the manufacturing process without altering the functionality of device 20.

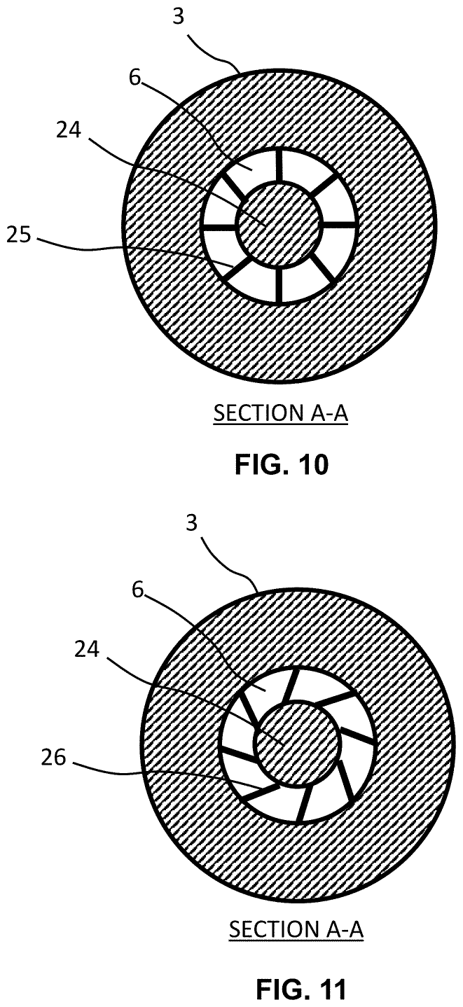

FIG. 10 shows a cross-section view, SECTION A-A, of an exemplary barrel 3 with an integral flow divertor 24 and a plurality of straight, integral support vanes 25, 25′, etc., that form internal flow channels 6, 6′, etc., according to the present invention. In this example, a total of eight, radially-oriented, straight support vanes 25, 25′, etc. are uniformly disposed around the circumference of flow divertor 24. Barrel 3 can be integrally formed with the flow divertor 24 and integral support vanes 25 (e.g., by casting, injection-molding, or 3-D printing).

FIG. 11 shows a cross-section view, SECTION A-A, of an exemplary barrel 3 with an integral flow divertor 24 and a plurality of angled, integral support vanes 25, 25′, etc., that form internal flow channels 6, 6′, etc., according to the present invention. In this example, a total of eight, radially-oriented, angled support vanes 26, 26′, etc. are uniformly disposed around the circumference of flow divertor 24. The integral, angled support vanes 26, 26′, etc. cause the liquid flowing through channels 6, 6′, etc. to have a helical (twist) component of its velocity field, which likely improves the degree of fluid/fat mixing. Barrel 3 can be integrally formed with the flow divertor 24 and integral support vanes 26 (e.g., by molding, over-molding, or 3-D printing).

According to another embodiment, all the materials used in device 20 are biocompatible and sterilizable.

What is claimed is:

1. A neonatal feeding syringe, comprising
a syringe comprising a tubular barrel defining an internal lumen, an open proximal end, and a distal end of the barrel comprising a nozzle in fluid communication with the lumen;
a plunger movably mounted within the lumen of the barrel, having a piston surface disposed on a distal end of the plunger, wherein the piston surface fluidically seals the lumen of the syringe barrel such that fluid is prevented from exiting an open proximal end of the barrel; and
a perforated mixing disc disposed within the lumen of the barrel, distal from the piston surface and proximal to the nozzle; the mixing disc comprising a proximally-facing face with a plurality of entry ports and a distally-facing face provided with a single, common exit port, wherein each entry port is individually connected to the common exit port by a channel that passes through the disc from the proximal face to the distal face of the mixing disc.

2. The neonatal feeding syringe of claim 1, wherein the mixing disc is fixed within the barrel.

3. The neonatal feeding syringe of claim 1, wherein the mixing disc is movable within the barrel.

4. The neonatal feeding syringe of claim 1, wherein the piston's distal face is coated with, or formed of, a lipophobic material.

5. The neonatal feeding syringe of claim 1, wherein the mixing disc is integrally formed with the syringe's barrel and is not removable.

6. The neonatal feeding syringe of claim 1, wherein the entire inside surface of the barrel is coated with a lipophobic material.

7. The neonatal feeding syringe of claim 1, wherein the mixing disc comprises a single exit port on the distal side of the disc; wherein the exit port has a larger diameter than the plurality of entry ports.

8. The neonatal feeding syringe of claim 2, wherein the mixing disc is adhesively attached to the distal end of the barrel.

9. The neonatal feeding syringe of claim 2, wherein the mixing disc is friction-fit within the distal end of the barrel.

10. The neonatal feeding syringe of claim 1, wherein the mixing disc comprises a rubber O-ring seal disposed around an outer circumference of the disc, which forms a seal against the lumen of the barrel.

11. A neonatal feeding syringe, comprising
a syringe comprising a tubular barrel defining an internal lumen, an open proximal end, and a distal end of the barrel comprising a nozzle in fluid communication with the lumen;
a plunger movably mounted within the lumen of the barrel, having a piston surface disposed on a distal end of the plunger, wherein the piston surface fluidically seals the lumen of the syringe barrel such that fluid is prevented from exiting an open proximal end of the barrel; and
a perforated mixing disc disposed within the lumen of the barrel, distal from the piston surface and proximal to the nozzle; the mixing disc comprising a proximally-facing face with a plurality of entry ports and a distally-facing face provided with a single, common exit port, wherein each entry port is individually connected to the common exit port by a channel that passes through the disc from the proximal face to the distal face of the mixing disc;
wherein the mixing disc is movable within the barrel.

12. The neonatal feeding syringe of claim 11, wherein the piston's interior surface is coated with, or formed of, a lipophobic material.

13. The neonatal feeding syringe of claim 11, wherein the lumen of the barrel is coated with a lipophobic material.

14. The neonatal feeding syringe of claim 11, wherein the piston's distal surface comprises a lipophobic material.

15. The neonatal feeding syringe of claim 11, wherein the mixing disc comprises a single exit port on the distal side of the disc; wherein the exit port has a larger diameter than each of the plurality of entry ports.

16. A neonatal feeding syringe, comprising
a syringe comprising a tubular barrel defining an internal lumen, an open proximal end, and a distal end of the barrel comprising a nozzle in fluid communication with the lumen;
a syringe a plunger movably mounted within the lumen of the barrel, having a piston surface disposed on a distal end of the plunger, wherein the piston surface fluidically seals the lumen of the syringe barrel such that fluid is prevented from exiting an open proximal end of the barrel; and
a perforated mixing disc disposed within the lumen of the barrel, distal from the piston surface and proximal to the nozzle; the mixing disc comprising a proximally-facing face with a plurality of entry ports and a distally-facing face provided with a single, common exit port, wherein each entry port is individually connected to the common exit port by a channel that passes through the disc from the proximal face to the distal face of the mixing disc;
wherein the mixing disc is made integral with a distal end of the barrel.

17. The neonatal feeding syringe of claim 16, wherein the mixing disc is supported within the barrel by a plurality of radially-oriented, integral, angled support vanes that impart a helical component of velocity of fluid flowing through channels defined by adjacent support vanes.

18. The neonatal feeding syringe of claim 16, wherein the lumen of the barrel is coated with a lipophobic material.

19. The neonatal feeding syringe of claim 16, wherein the mixing disc is integrally formed with the syringe's barrel and is not replaceable.

20. The neonatal feeding syringe of claim 16, wherein the mixing disc comprises a single exit port on the distal side of the disc; wherein the exit port has a larger diameter than each of the plurality of entry ports.
